(19) United States
(12) Patent Application Publication
(10) Pub. No.: US 2014/0080031 A1
(43) Pub. Date: Mar. 20, 2014

(54) Dual Layered ePTFE Polyelectrolyte Membranes

(71) Applicants: Lijun Zou, Rochester, NY (US); Timothy J. Fuller, Pittsford, NY (US); Michael R. Schoeneweiss, West Henrietta, NY (US)

(72) Inventors: Lijun Zou, Rochester, NY (US); Timothy J. Fuller, Pittsford, NY (US); Michael R. Schoeneweiss, West Henrietta, NY (US)

(73) Assignee: GM GLOBAL TECHNOLOGY OPERATIONS LLC, Detroit, MI (US)

(21) Appl. No.: 13/617,758

(22) Filed: Sep. 14, 2012

(51) Int. Cl. H01M 8/10

(52) U.S. Cl. 429/482; 429/479; 429/491; 429/495; 429/494; 429/492

(57) ABSTRACT

A supported membrane for fuel cell applications includes a first expanded polytetrafluoroethylene support and a second expanded polytetrafluoroethylene support. Both the first and second expanded polytetrafluoroethylene supports independently have pores with a diameter from about 0.1 to about 1 microns and a thickness from about 4 to 12 microns. The supported membrane also includes an ion conducting polymer adhering to the first expanded polytetrafluoroethylene support and the second expanded polytetrafluoroethylene support such that the membrane has a thickness from about 10 to 25 microns.

In at least one aspect, the present invention relates to mechanically durable polyelectrolyte membranes for fuel cells.

### BACKGROUND

Fuel cells are used as an electrical power source in many applications. In particular, fuel cells are proposed for use in automobiles to replace internal combustion engines. A commonly used fuel cell design uses a solid polymer electrolyte (“SPE”) membrane or proton exchange membrane (“PEM”) to provide ion transport between the anode and cathode.

In proton exchange membrane type fuel cells, hydrogen is supplied to the anode as fuel and oxygen is supplied to the cathode as the oxidant. The oxygen can either be in pure form (O₂) or air (a mixture of O₂ and N₂). PEM fuel cells typically have a membrane electrode assembly (“MEA”) in which a solid polymer membrane has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel and oxidant to disperse over the surface of the membrane facing the fuel- and oxidant-supply electrodes, respectively. Each electrode has finely divided catalyst particles (for example, platinum particles) supported on carbon particles to promote oxidation of hydrogen at the anode and reduction of oxygen at the cathode. Protons flow from the anode through the ionically conductive polymer membrane to the cathode where they combine with oxygen to form water which is discharged from the cell. The MEA is sandwiched between a pair of porous gas diffusion layers (“GDL”) which, in turn, are sandwiched between a pair of non-porous, electrically conductive elements or plates. The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, many individual fuel cells are arranged in stacks in order to provide high levels of electrical power.

In some prior art fuel cells, composite or supported membranes are used for the polymer membrane. Such supported membranes offer some improvements in mechanical stability. Although the prior art membranes work reasonably well, these membranes utilize supports having a thickness of over 20 microns. Such thick supports adversely affect performance and have considerable anisotrophy. Membranes made with thin single layers of ePTFE are susceptible to electrical shorting.

Accordingly, there is a need for membranes with improved fuel cell ion conducting properties.

### SUMMARY OF THE INVENTION

The present invention solves at least one problem of the prior art by providing a supported membrane for a fuel cell. The supported membrane includes a first expanded polytetrafluoroethylene support and a second expanded polytetrafluoroethylene support. Both the first and second expanded polytetrafluoroethylene supports independently have pores with a diameter from about 0.1 to about 1 microns and a thickness from about 4 to 12 microns. The supported membrane also includes an ion conducting polymer imbibing into the first expanded polytetrafluoroethylene support and the second expanded polytetrafluoroethylene support such that the membrane has a thickness from about 10 to 25 microns.

In another embodiment, a membrane electrode assembly for a fuel cell incorporating the supported membrane set forth above is provided. The membrane electrode assembly includes a supported membrane having a first side and a second side. The supported membrane includes a first expanded polytetrafluoroethylene support and a second expanded polytetrafluoroethylene support. Both the first and second expanded polytetrafluoroethylene supports independently have pores with a diameter from about 0.1 to about 1 microns and a thickness from about 4 to 12 microns. The supported membrane also includes an ion conducting polymer imbibing into the first expanded polytetrafluoroethylene support and the second expanded polytetrafluoroethylene support such that the membrane has a thickness from about 10 to 25 microns. The membrane electrode assembly also includes an anode catalyst layer disposed over the first side of the proton conducting layer, and a cathode catalyst layer disposed over the second side of the proton conducting layer.

### BRIEF DESCRIPTION OF THE DRAWINGS

Exemplary embodiments of the present invention will become more fully understood from the detailed description and the accompanying drawings, wherein:

FIG. 1 is a schematic illustration of a fuel cell that incorporates a supported membrane having two thin support layers;

FIG. 2 is a schematic cross section of a supported membrane;

FIG. 3 is a flowchart depicting a method for forming the supported membranes;

FIG. 4 provides a cross-section optical image of a membrane with a PFCB-ionomer containing layer sandwiched between two PFSA surface skin layers and a D1326, ePTFE support layer;

FIG. 5 provides a cross-section scanning electron microscopy (SEM) image of a membrane with a PFCB-containing layer with two NB ePTFE support layers impregnated with PFSA ionomer;

FIG. 6 provides the in-plane proton conductivity of 1-layer ePTFE supported (PFCB/D 1326) and 2-layer ePTFE supported (PFCB/2NB) PFCB membranes under relative humidity from 20% to 100%; and

FIG. 7 provides small scale fuel cell polarization curves of PFCB/D1326 and PFCB/2NB membranes at 55% RHₒᵤₜ, 2.0/1.8 (H₂/air) stoichiometry, 150 kPa, 95° C. with a 50 cm² active catalyst area and 0.4 mg Pt/cm² on the cathode and 0.05 mg Pt/cm² on the anode.

### DESCRIPTION OF THE INVENTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; molecular weights provided for any polymers refers to number average molecular weight; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

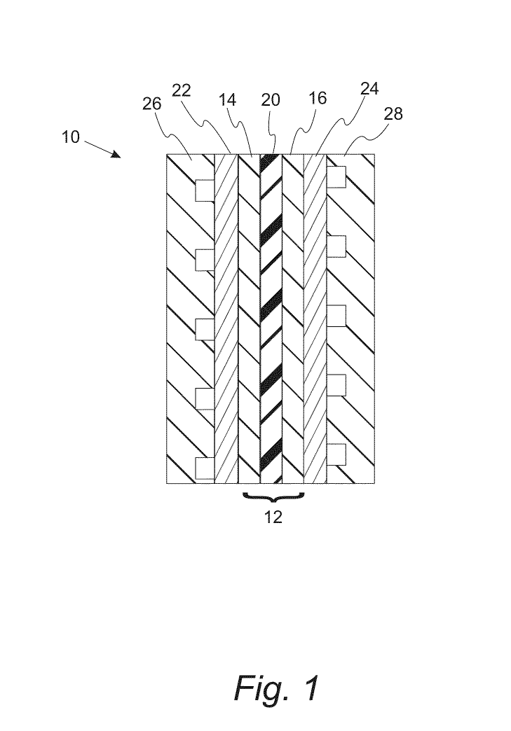

With reference to FIG. 1, a fuel cell having a membrane electrode assembly that incorporates a supported (i.e., composite) membrane is provided. Fuel cell 10 includes the membrane electrode assembly 12 which includes anode catalyst layer 14, cathode catalyst layer 16, and ion conducting membrane (i.e., proton exchange membrane, ionomer, etc.) 20. Supported membrane 20 is interposed between anode catalyst layer 14 and cathode catalyst layer 16 with anode catalyst layer 14 disposed over the first side of supported membrane 20 and cathode catalyst layer 16 disposed over the second side of supported membrane 20. The details of supported membrane 20 are set forth below. In a variation, fuel cell 10 also includes porous gas diffusion layers 22 and 24. Gas diffusion layer 22 is disposed over anode catalyst layer 14 while gas diffusion layer 24 is disposed over cathode catalyst layer 16. In yet another variation, fuel cell 10 includes anode flow field plate 26 disposed over gas diffusion layer 22 and cathode flow field plate 28 disposed over gas diffusion layer 24.

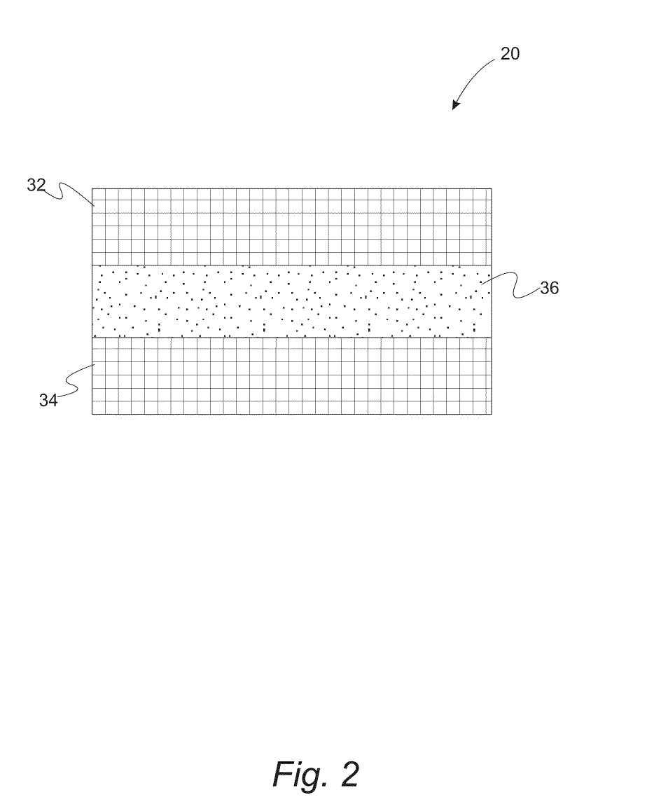

With reference to FIG. 2, a schematic cross section of a supported membrane is provided. Supported membrane 20 includes first expanded polytetrafluoroethylene support (ePTFE) 32 and second expanded polytetrafluoroethylene support 34. Both first expanded polytetrafluoroethylene support 32 and second expanded polytetrafluoroethylene support 34 independently have pores with a diameter from about 0.1 to about 1 microns and a thickness from about 4 to 12 microns. Supported membrane 20 also includes an ion conducting polymer imbibed into the first expanded polytetrafluoroethylene support 32 and the second expanded polytetrafluoroethylene support 34 such that the membrane has a thickness from about 10 to 25 microns. Typically, ion conducting polymer 36 includes protogenic groups such as —SO₂Y, —PO₃H₂, —COY, and the like where Y is an —OH, a halogen, or a C₁₋₆ ester. In a variation, first expanded polytetrafluoroethylene support 32 and second expanded polytetrafluoroethylene support 34 are positioned orthogonally to each other so that the anisotropy of the ePTFE is improved.

In a refinement, first expanded polytetrafluoroethylene support 32 and second expanded polytetrafluoroethylene support 34 each independently have a density from about 0.15 to about 0.4 g/cm³. In another refinement, first expanded polytetrafluoroethylene support 32 and second expanded polytetrafluoroethylene support 34 each independently have a density from about 0.18 to about 0.22 g/cm³. In still another refinement, first expanded polytetrafluoroethylene support 32 and second expanded polytetrafluoroethylene support 34 each independently have a Gurley Number from about 1 to 30. As used herein, a Gurley Number is the time in seconds it takes for 100 cc of air to pass through one-square inch of membrane when a constant pressure of 4.88 inches of water is applied. In yet another refinement, first expanded polytetrafluoroethylene support 32 and second expanded polytetrafluoroethylene support 34 each independently have a Gurley Number from about 1 to 20. In yet another refinement, first expanded polytetrafluoroethylene support 32 and second expanded polytetrafluoroethylene support 34 each independently have a Gurley Number from about 2 to 10.

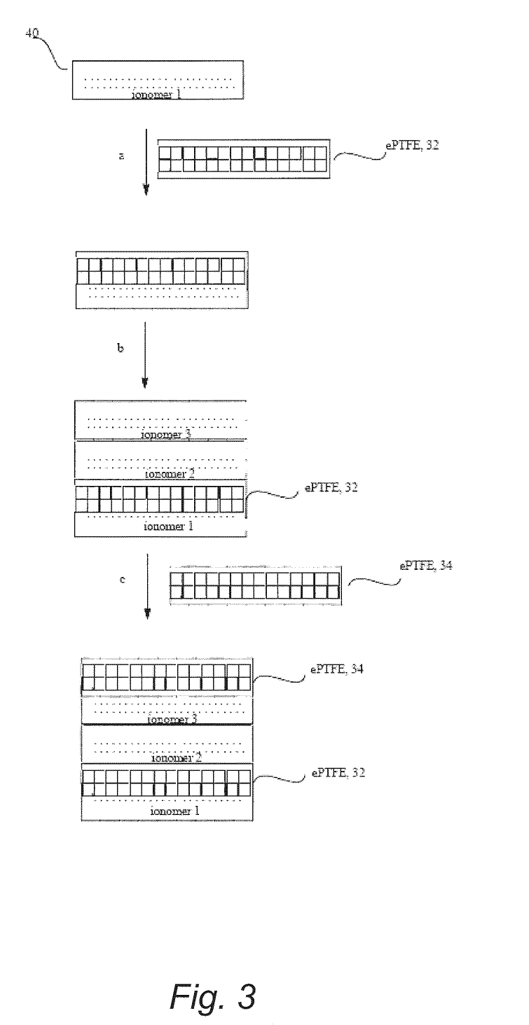

With reference to FIG. 3, a method for forming the supported membranes set forth above is provided. In this embodiment, the supported membrane is reinforced with two polytetrafluoroethylene supports to improve the durability and performance. Typical supports are expanded having pores with a diameter from about 0.1 to about 1 microns and a thickness from about 4 to 12 microns. Layer 40 of ion conducting polymer (Nafion DE2020®)is first coated onto a backer release film layer and then an expanded polytetrafluoroethylene support 32 (step a) is applied to the wet film. The Nafion® imbibes into the ePTFE and the composite is dried. Then two distinct wet film layers are simultaneously applied to the ePTFE imbibed with Nafion®. The first layer nearer to the ePTFE consists of wet PFCB ionomer and Kynar Flex 2751® layer and a wet surface layer of Nafion DE2020°. Then a layer of ePTFE (that had been pre-wetted with a 1 wt. % solution of Nafion DE2020° in isopropanol) is laid on top. The ionomer imbibes into the ePTFE. The composite is dried at 80° C. and then is annealed at 140° C. for 16 hours. A sandwich structure 30 is formed. The resulting sandwich membranes have survived more than 20,000-dry to wet relative humidity (RH) cycles with less than 10 sccm leak. Membranes that have two ePTFE supports are stronger and more durable than those made with a single layer, thick ePTFE support.

As set forth above, membrane electrode assembly 12 includes an ion conducting polymer having protogenic groups. Examples of such ion conducting polymers include, but are not limited to, perfluorosulfonic acid (PFSA) polymers, polymers having perfluorocyclobutyl (PFCB) moieties, and combinations thereof. Examples of useful PFSA polymers include a copolymer containing a polymerization unit based on a perfluorovinyl compound represented by:

CF₂═CF—(OCF₂CFX¹)ₘ—Oᵣ—(CF₂)_{q}—SO₃H

where m represents an integer of from 0 to 3, q represents an integer of from 1 to 12, r represents 0 or 1, and X¹ represents a fluorine atom or a trifluoromethyl group and a polymerization unit based on tetrafluoroethylene. Suitable polymers including perfluorocyclobutyl moieties are disclosed in U.S. Pat. Pub. No. 2007/0099054, U.S. Pat. No. 7,897,691 issued Mar. 1, 2011; U.S. Pat. No. 7,897,692 issued Mar. 1, 2011; U.S. Pat. No. 7,888,433 issued Feb. 15, 2011, U.S. Pat. No. 7,897,693 issued Mar. 1, 2011; and U.S. Pat. No. 8,053,530 issued Nov. 8, 2011, the entire disclosures of which are hereby incorporated by reference. Examples of perfluorocyclobutyl moieties are:

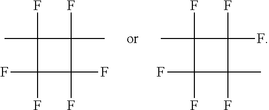

In a variation, the ion-conducting polymer having perfluorocyclobutyl moieties includes a polymer segment comprising polymer segment 1:

E₀-P₁-Q₁-P₂ 1

wherein:
E₀ is a moiety, and in particular, a hydrocarbon-containing moiety, that has a protogenic group such as —SO₂X, —PO₃H₂, —COX, and the like;
P₁, P₂ are each independently absent, —O—, —S—, —SO—, —CO—, —SO₂—, —NH—, NR₂—, or —R₃—;
R₂ is C₁₋₂₅ alkyl, C₆₋₂₅ aryl or C₆₋₂₅ arylene;
R₃ is C₁₋₂₅ alkylene, C₁₋₂₅perfluoroalkylene, perfluoroalkyl ether, alkylether, or C₁-₂₅ arylene;
X is an —OH, a halogen, an ester, or

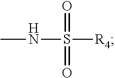

R₄ is trifluoromethyl, C₁-₂₅ alkyl, C₂₋₂₅ perfluoroalkylene, or C₆₋₂₅ aryl; and
Q₁ is a fluorinated cyclobutyl moiety.

The following examples illustrate the various embodiments of the present invention.

Those skilled in the art will recognize many variations that are within the spirit of the present invention and scope of the claims.

Two types of ePTFE samples, D1326 from Donaldson Membranes and NB from Ningbo Changqi Porous Membrane Technology, are used to produce supported fuel cell membranes. The physical properties of these samples parameters are listed in Table 1. As it is shown, NB ePTFE is thinner, more porous and less dense than D1326.

TABLE 1
Physical parameters of D1326 and NB ePTFE samples.

| ePTFE | Thickness | Gurley Air Flow | Max. Pore Size | Density |
|---|---|---|---|---|
| Sample | (μm) | (s/100 cc) | (μm) | (g/cm³) |
| D1326 | 17.8 | 46 | 0.1 | 0.32 |
| NB | 10 | 4 | 1 | 0.25 |

### MEMBRANE EXAMPLES

### Example 1

### PFCB-Ionomer/D1326 Membrane

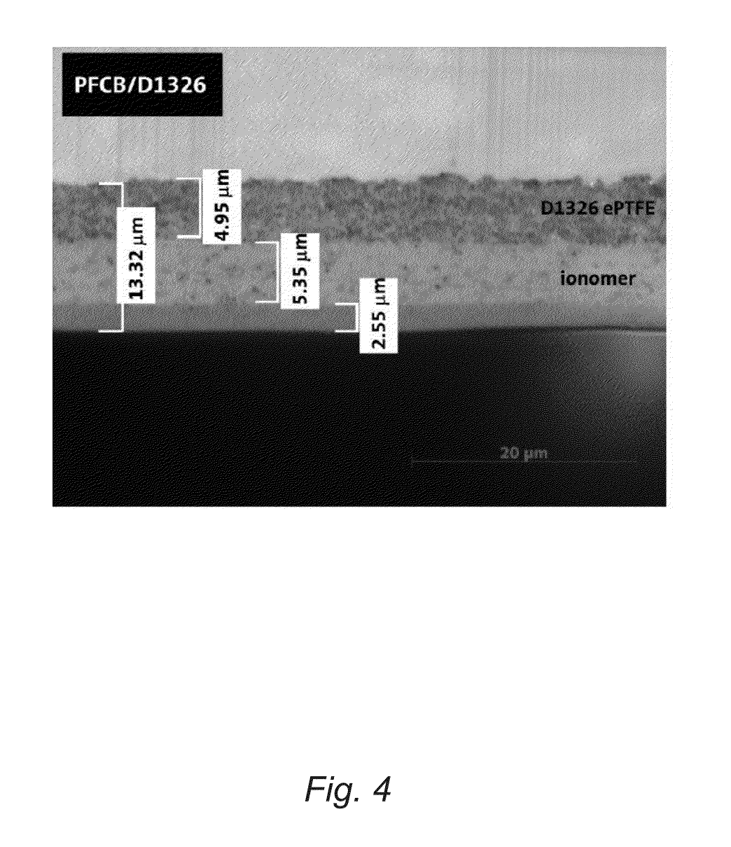

FIG. 4 provides a cross-section optical image of a membrane with a PFCB ionomer-containing layer sandwiched between two PFSA skin layers with a D1326, ePTFE support layer. The coating substrate (backer release film) used in this example is a 26-μm thick polyimide film with a 2-μm-thick fluorinated ethylene-propylene (FEP) surface coating on both sides (the total backer thickness is 30 μm). In the image, from the bottom to the top, are NAFION® (DE2020) (2.55-μm thick) coated from a 10 wt % DMAc solution, perfluorocyclobutane (PFCB)-ionomer with 30% KYNAR FLEX® 2751 (5.35-μm thick) coated from a 7 wt % DMAc solution, and NAFION® (DE2020) coated from a 10 wt % DMAc solution with a D1326 ePTFE film at 4.55 μm-thick. The total membrane thickness is about 13-μm thick. The coating details are as follows. The Erichsen coater is set at 23° C. with a piece of fluorinated ethylene-propylene (FEP)-coated polyimide film sheet as the substrate on top of the vacuum platen. The coating speed is set at 12.5 mm/s and the coating direction is from left to right. The ePTFE support is pretreated with a 1 wt % NAFION® DE2020 solution in isopropanol at 23° C. using a 3-mil (10″ coating width) Bird applicator. On the backer film situated on the coater, three Bird applicators are placed in order. A 3-mil applicator (10″ coating width) with masking tape shims, a 3-mil applicator (9″ coating width) with Mylar (32 μm-thick) tape shims, and 1-mil applicator (10″ coating width) are arranged from left to right. The bottom NAFION® solution is placed in front of the 1-mil Bird applicator and the PFCB-ionomer solution is placed in front of the middle 3-mil Bird applicator, and the top NAFION® DE2020 solution is placed in front of the most left Bird applicator. The Bird applicators are separated by spacers (0.5-inch diameter stainless steel, hexagonal screw nuts) and the coatings are cast all together, and then overlaid with the pretreated ePTFE support with the shiny side down. The composite is dried at 80° C., and then annealed at 140° C. for 4 hours.

### Example 2

### PFCB-Ionomer/2NB Membranes

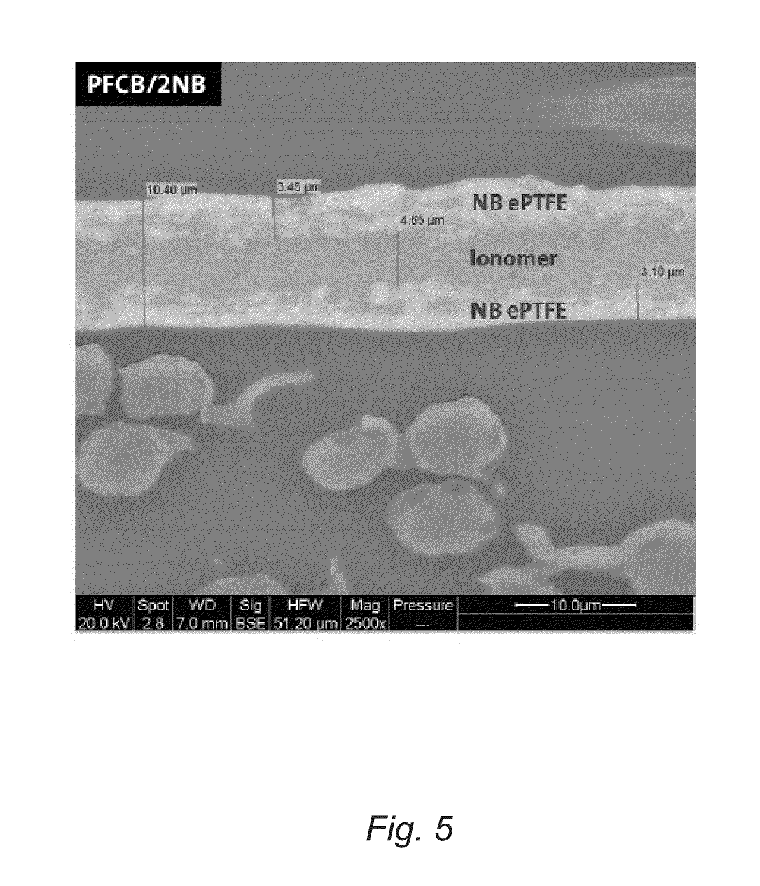

FIG. 5 provides a cross-section SEM image of a membrane with a PFCB-ionomer layer with two NB ePTFE support layers impregnated with PFSA ionomer. The coating substrate (backer release film) used in this example is a 26-μm thick polyimide film with 2-μm-thick fluorinated ethylene-propylene (FEP) surface coating on both sides (the total backer thickness is 30 μm). In the image, from the bottom to the top, are NAFION® (DE2020) (10 wt % isopropanol) impregnated NB ePTFE layer (3.10-μm thick), perfluorocyclobutane (PFCB) ionomer with 30% KYNAR FLEX® 2751 (4.65-μm thick) coated from a 7 wt % DMAc solution, and NAFION® (DE2020) (coated from 10 wt % isopropanol) impregnated NB ePTFE layer (3.45-μm thick). The total membrane thickness is about 11-μm thick. The coating details are as follows: The Erichsen coater is set at 23° C. with a piece of fluorinated ethylene-propylene (FEP)-coated polyimide film sheet as the substrate on top of the vacuum platen. The coating speed is set at 12.5 mm/s and the coating direction is from left to right. A wet layer of NAFION® (DE2020) solution at 10 wt % in isopropanol is coated by using a 1-mil (10″ coating width) Bird applicator and then overlaid with the NB ePTFE support film. The film is dried at 50° C. and then cooled back down to 23° C. Two Bird applicators are placed in order. A 1-mil applicator (9″ coating width) with two layers of Mylar (32×2 μm-thick) tape shims, and a 3-mil applicator (10″ coating width) with Mylar (32 μm-thick) tape shims, are arranged from right to left. The PFCB-ionomer solution is placed in front of the 1-mil Bird applicator and the NAFION® solution is placed in front of the 3-mil Bird applicator. The Bird applicators are separated by spacers (0.5-inch diameter stainless steel, hexagonal screw nuts) and the coatings are cast all together, and then overlaid with the pretreated NB ePTFE support (1 wt % Nafion® DE2020 solution in isopropanol at 23° C. using a 3-mil (10″ coating width Bird applicator) with the shiny side down. The composite is dried at 80° C., and then annealed at 140° C. for 4 hours.

### Results

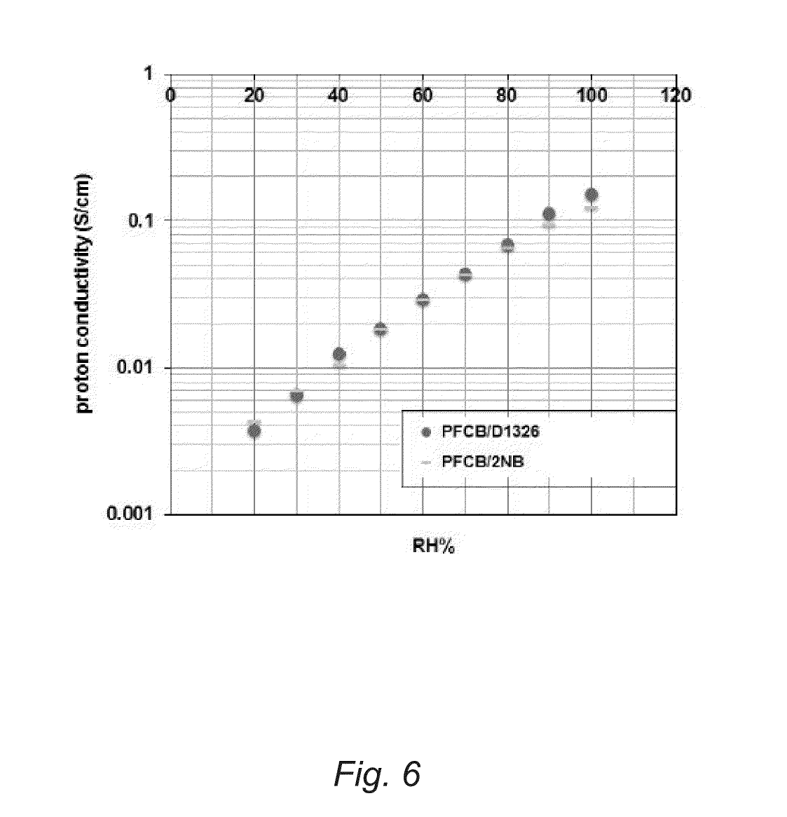

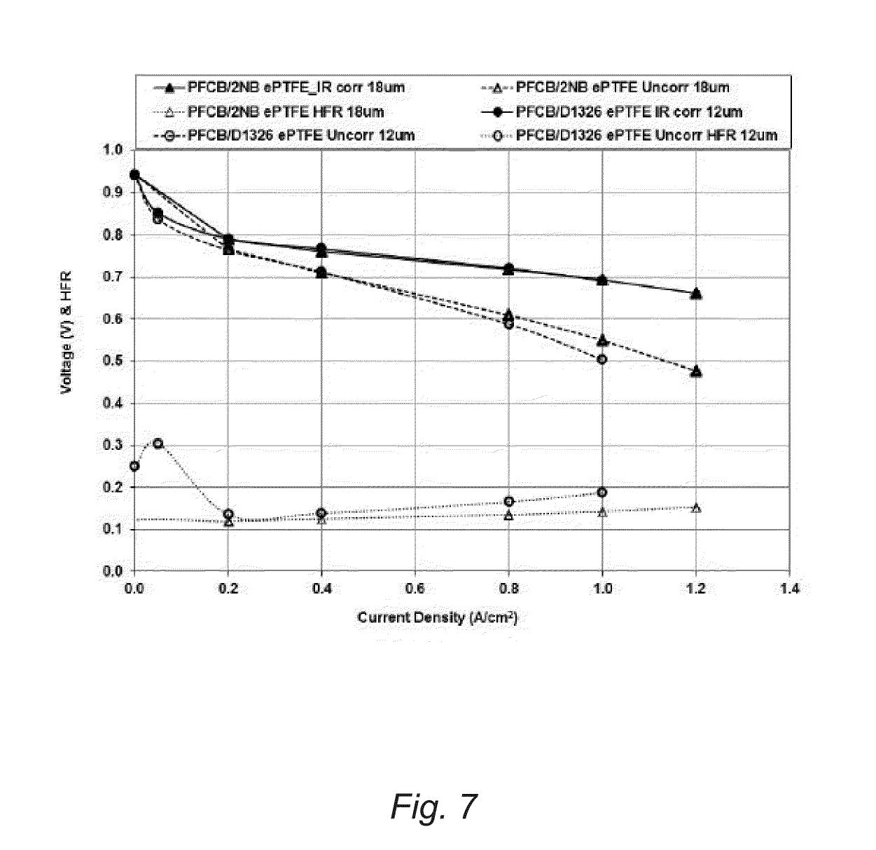

FIG. 6 shows the in-plane proton conductivity of PFCB-ionomer/D1326 membrane (Example 1) is about the same as PFCB/2NB membrane (Example 2) at 80° C. under relative humidity from 20% to 100%. FIG. 7 shows the small scale dry fuel cell performance (55% RHₒᵤₜ) of two thin ePTFE supported PFCB/2 NB membranes is much better than the one thick ePTFE supported PFCB/D1326 membrane. The PFCB/2 NB membrane runs to 1.2 A/cm² and PFCB/D1326 membrane only runs to 1.0 A/cm² under the same test condition. For durability comparison, the PFCB/2NB membrane survives more than 20,000 dry (2 minutes) to wet (2 minutes) RH cycles at 80° C. with less than 10 sccm leak, while PFCB/D1326 membrane exhibits a leak rate above 10 sccm (standard cubic centimeters) at 5000 cycles.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A supported membrane of a fuel cell, the supported membrane comprising:
a first expanded polytetrafluoroethylene support having pores with a diameter from 0.1 to 1 microns and a thickness from 4 to 12 microns;
a second expanded polytetrafluoroethylene support having pores with a diameter from 0.1 to 1 microns and a thickness from 4 to 12 microns; and
an ion conducting polymer imbibing into the first expanded polytetrafluoroethylene support and the second expanded polytetrafluoroethylene support such that the membrane has a thickness from 10 to 25 microns.

2. The supported membrane of claim 1 wherein the first expanded polytetrafluoroethylene support and second expanded polytetrafluoroethylene support each independently have a density from 0.15 to 0.4 g/cm³.

3. The supported membrane of claim 1 wherein the first expanded polytetrafluoroethylene support and second expanded polytetrafluoroethylene support each independently have a density from 0.18 to 0.22 g/cm³.

4. The supported membrane of claim 1 wherein the ion conducting polymer includes a plurality of protogenic groups.

5. The supported membrane of claim 4 wherein the protogenic groups are SO₂Y, PO₃H₂, and COY and Y is —OH, a halogen, or an ester.

6. The supported membrane of claim 1 wherein the ion conducting polymer is a perfluorosulfonic acid polymer.

7. The supported membrane of claim 1 wherein the ion conducting polymer has the following formula:
CF₂═CF—(OCF₂CFX¹)ₘ—Oᵣ—(CF₂)_{q}—SO₃H
where m represents an integer of from 0 to 3, q represents an integer of from 1 to 12, r represents 0 or 1, and X¹ represents a fluorine atom or a trifluoromethyl group and a polymerization unit based on tetrafluoroethylene.

8. The supported membrane of claim 1 wherein the ion conducting polymer is a perfluorocyclobutyl polymer.

9. The supported membrane of claim 1 wherein the ion conducting polymer includes perfluorocyclobutyl groups having the following formula:

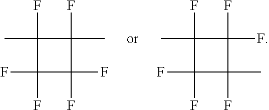

10. A membrane electrode assembly for a fuel cell, the membrane electrode assembly comprising:
a supported membrane having a first side and a second side, the supported membrane comprising:
a first expanded polytetrafluoroethylene support having pores with a diameter from 0.1 to 1 microns and a thickness from 4 to 12 microns;
a second expanded polytetrafluoroethylene support having pores with a diameter from 0.1 to 1 microns and a thickness from 4 to 12 microns; and
an ion conducting polymer imbibing into the first expanded polytetrafluoroethylene support and the second expanded polytetrafluoroethylene support such that the membrane has a thickness from 10 to 25 microns;
an anode catalyst layer disposed over the first side of the proton supported membrane; and
a cathode catalyst layer disposed over the second side of the proton supported membrane.
